(19) United States
(12) Patent Application Publication
(10) Pub. No.: US 2026/0036834 A1
(43) Pub. Date: Feb. 5, 2026

(54) WEARABLE OPTICAL DEVICE AND METHOD OF PRODUCING AN OPTICAL COMPOSITE MATERIAL FOR SUCH DEVICE

(71) Applicant: XPANCEO RESEARCH ON NATURAL SCIENCE LLC, Dubai (AE)

(72) Inventors: Aleksey V. Arsenin; Valentin S. Volkov, Dolgoprudnyy (RU); Georgii A. Ermolaev, Dolgoprudnyy (RU); Alexander V. Syuy, Moscow (RU); Gleb I. Tselikov, Sarov (RU)

(21) Appl. No.: 19/100,440

(22) PCT Filed: Jul. 5, 2023
(86) PCT No.: PCT/RU2023/050166

§ 371 Date: Jan. 31, 2025

(30) Foreign Application Priority Data
Nov. 12, 2022 (RU) 2022129388

(51) Int. Cl. G02C 7/04

(52) U.S. Cl. CPC G02C 7/041

(57) ABSTRACT

Inventions relate to wearable optical devices. The device comprises optical composite layered polymer material with van der Waals nanoparticles with refractive index higher than 2.8. The difference between the refractive indices of layers comprises not less than 0.3. Method of producing such material comprises: (i) producing the nanoparticles from a high-refractive material, using the method of femtosecond laser fragmentation or ablation in liquid; (ii) distributing the nanoparticles over the polymer by mixing; (iii) forming the layers on substrates using the centrifugation process with subsequent polymerization; (iv) forming the optical composite material from the layers using the liquid transfer method. The technical effect—panoramically expanding the field of view up to the level exceeding physiological capabilities of the human eye.

### TECHNICAL FIELD

The group of inventions relates to the field of optics and specifically to wearable optical devices based on optical composite materials that make it possible to panoramically expand the field of view, as well as to the methods of producing an optical composite material for such device.

### BACKGROUND ART

The prior art lenses are known that are produced from optical materials having a radial-spherical refractive index gradient, such as the Luneberg lens (see Luneburg R. K. Mathematical theory of optics Berkeley, CA: University of California Press, 1964; Roman Ilinsky. Gradient-index meniscus lens free of spherical aberration—Journal of Optics A: Pure and Applied Optics, Volume 2, Number 5, September 2000, pp. 449-451.). Also, such lenses can be produced using the optical materials having an axial or radial refractive index gradient. The main advantages of such type of lenses are increased focal power, reduced aberrations, and a wide field of view.

The human eye is the most obvious example of gradient optics in nature, having the lens refractive index from approximately 1.406 in the central layers to 1.386 in the less dense layers of the lens (see Hecht, Eugene; Zaja̧c, Alfred, (1987). Optics (2nd ed.). Reading, MA: Addison-Wesley. 178). This enables the human eye to obtain an image with good resolution and low aberration both at short and long distances (Shirk J S, Sandrock M, Scribner D, Fleet E, Stroman R, Baer E, Hilter A. (2006) NRL Review pp. 53-61). At the same time, the human eye's field of view comprises up to 120 degrees, while the field of clear vision (the range of angles at which the human eye can recognize symbols)—approximately 30 degrees vertically and 40 degrees horizontally (Bernard C. Kress, «Optical Architectures for Augmented-, Virtual-, and Mixed-Reality Headsets», SPIE Press, 2020).

Various prior art methods are known to produce the optical materials with refractive index gradient, for example, the sol-gel method (see U.S. Pat. No. 8,763,430B2, cl. C03B19/12, published 1 Jul. 2014). Also, the glass with refractive index gradient can be produced using neutron irradiation, chemical vapor deposition, ion exchange, ion implantation, crystal growing, glass layer overlapping, etc. The main problem of producing the optical materials with refractive index gradient consists in technological complexity of the process and in the gradient range being limited by potential refractive indices of the employed material.

The prior art discloses a method of producing an optical material with a refractive index gradient, wherein the method consists in using the process of controlled diffusion of the components in the blanks of glass, plastic or other suitable optical material applicable for producing both radial and cylindrical refractive index gradient (see application U.S. Pat. No. 5,262,896A, cl. G02B3/00, published 16 Nov. 1993). Disadvantage of the prior art method is labor-consuming grinding and polishing of the cylinder lenses to the required precision, as well as low refractive index gradient value (about 0.01-0.03) due to limitations of diffusion laws. Furthermore, the transmittance of the obtained material in the visible spectral range does not exceed 50%, while the field of view does not exceed 25-35 degrees.

The prior art discloses a method of producing a lens with a refractive index gradient, wherein the method consists in copolymerization of two different monomers that are subjected to diffusion (see Wu, S. P., Nihei, E., Koike, Y. «Large Radial Graded-Index Polymer», Appl. Opt. 35(1), 28, 1996). Incomplete diffusion results in a composition gradient and, consequently, in a refractive index gradient over the whole material, while making it possible to use two different monomers, as well as doping the polymer with impurity The main disadvantages of the prior art method are low refractive index gradient value (about 0.01-0.03) due to limitations of diffusion laws, as well as a short lifetime of the produced materials due to migration of the doping impurities. Furthermore, the transmittance in the visible spectral range does not exceed 60%, while the field of view does not exceed 25-35 degrees.

The prior art discloses a method of producing a contact or intraocular lens from an optical material with a refractive index gradient, produced by polymerizing a master polymer in the central part and then diffusing into said master polymer a polymer with a lower refractive index to produce a gradient of up to 0.4 (see U.S. Pat. No. 7,857,848B2, cl. G02B1/04, published 28 Dec. 2010). The disadvantage of the prior art method consists in poor intermediate vision of the obtained lenses, low transmittance (lower than 50%), visual artifacts: halos, dissipation and glare, absence of accommodation, as well as limited field of view (187 degrees maximum).

The prior art discloses a method of producing a material with a refractive index gradient, in particular, in the form of large sheets, wherein the method consists in producing a hierarchically multilayered polymer composite from an ordered set of polymer films (of immiscible, miscible or partly miscible polymers), each having its own refractive index, after which the multilayer polymer composite sheet is formed up (see U.S. Pat. No. 7,002,754B2, cl. G02B3/00, published 21 Feb. 2006). The prior art method makes it possible to produce a continuous, discrete, or stepwise refractive index gradient ranging from 0.01 to 1.0 in any axial, radial, or radial-spherical direction. Furthermore, a dynamic reversible variation of the refractive index gradient can be achieved, which makes it possible to vary the focal distance of the lenses made from said material. Disadvantages of the prior art method are the complexity of production, including the necessity to use thermoplastic polymers, as well as the impossibility to produce a material having the refractive index gradient higher than 1.0 and the transmittance higher than 50% in the visible spectral range, while the achieved field of view does not exceed 273 degrees.

The closest, in terms of technical substance, to the suggested invention is a wearable optical device comprising a composite material consisting of at least two layers of optically transparent polymer with nanoparticles, wherein said layers have different refractive indices (see U.S. Pat. No. 11,327,438B2, cl. G02B 5/08, G03H1/04, published 10 May 2022). Said document discloses a method of producing an optical composite material, comprising the following steps: producing the nanoparticles, distributing the nanoparticles over the polymer, forming the layers with different refractive indices from the optically transparent polymer with nanoparticles, forming a multilayer blank and bonding the optical composite material together. The main disadvantage of the prior art device and the method is the use of polymeric nanoparticles, which results in forming a relatively low refractive index gradient (about 0.2) and does not allow to achieve a sufficiently wide field of view.

The technical problem is to eliminate said disadvantages.

### SUMMARY OF INVENTION

The technical effect, as related to the device, consists in enhancing its functionality and, in particular, expanding the field of view up to the level exceeding the physiological capabilities of the human eye. As related to the device, said problem has been solved, and the technical effect has been achieved by that in the wearable optical device containing a composite material comprising at least two layers of optically transparent polymer with nanoparticles, wherein said layers have different refractive indices, the nanoparticles are made of high-refractive material having the refractive index higher than 2.8, and the difference between the refractive indices of said layers comprises not less than 0.3. The employed high-refractive material can be ZnO, TiO₂, or ZnS. The employed high-refractive material can also be a van der Waals material consisting of two-dimensional layers bonded together by van der Waals forces, such as, without limitation, transition metal dichalcogenide, hexagonal boron nitride, graphite, MoS₂, MoSe₂, WS₂, WSe₂, SnS₂, SnSe₂, PtS₂, PtSe₂, PtTe₂, ReS₂, ReSe₂, Cd₃ As₂, Cd₃Sb₂, Cr₂AlC, Cr₂C, Mn₂AlC, Mo₂C, Mo₂Ga₂C, Mo₃AlC₂, Nb₂AlC, Nb₂C, Nb₄ AlC₃, Nb₄C₃, Ta₂C, Ta₄AlC₃, Ti₂AlC, Ti₂AlN, Ti₂C, Ti₂N, Ti₃AlC₂, Ti₃C₂, Ti₃CN, Ti₃ SiC₂, Ti₄N₃, V₂AlC, V₂C, V₄AlC₃, V₄C₃, PdS₂, PdSe₂, PdTe₂, ZrS₂, ZrSe₂, GaSe, Sb₂Te₃, GaS, GaSe, GaTe, Ca(OH)₂, Mg(OH)₂, MnO₂, MoO₃, Sb₂O₃, Sb₂OS₂, Sb₂S₃, Sb₂Se₃, Sb₂Te₃, As₂S₃, As₂Se₃, As₂Te₃, Bi₂O₂Se, Bi₂S₃, Bi₂Se₃, Bi₂Te₃, BiSbTe₃, AsP, CdI₂, CdPS₃, CuS, CoPS₃, Cr₂Ge₂Te₆, Cr₂S₃, CrBr₃, CrCl₃, CrGeTe₃, CrPS₃, CrSeBr, CuCrP₂ S₆, CuIn₇Se₁₁, FeCl₂, FePS₃, FePSe₃, GaGeTe, GaInS₃, GaSeTe, GaSSe, GaPS₄, GaSTe, HfSe₂, HfS₂, In₂S₃, In₂Se₃, InSe, InTe, InSeBr, InSnSe, MoTe₂, WTe₂, NbS₂, NbSe₂, NbSe₃, VSe₂, ZrSe₃, MoSSe, MoWSe₂, MoWS₂, MoWTe₂, MoNbSe₂, MoO_{2.5}Cl_{0.5}, MoReS₂, MoTaSe₂, MoVSe₂, Na₂Co₂TeO₆, Nb₂SiTe₄, NbReS₂, NbReSe₂, NbS₃, Ni₂ SiTe₄, Ni₃TeO₆, NiCl₂, NiI₂, NiPS₃, PbI₂, PbTe, ReNbS₂, ReNbSe₂, ReSSe, Sb₂OS₂, SbAsS₃, SbSe, SbSi, SiP, SnPSe₃, SnS, SnSe, TaS₂, TaS₃, TaSe₂, TaWSe₂, TlSe, TiBr₃, SnTe₂, TiS₂, TiS₃, TlGaS₂, TlGaSe₂, TlGaTe₂, TlInS₂, WNbSe₂, WReS₂, ZrS₂, ZnIn₂S₄, ZnPS₃, ZnPSe₃, ZrGeTe₄, ZrS₃, ZrSe₂, ZrTe₂ or ZrTe₃. Said polymer preferably has a refractive index in the range from 1.3 to 1.8, and, in particular, said polymer is represented by polyvinyl alcohol, hydroxyethyl methacrylate, polydimethylsiloxane, polylactide, polymethyl methacrylate, polymethylpentene, polycarbonate or polyetherimide. Said layers can have different refractive indices due to the size of nanoparticles in one layer being larger than the size of nanoparticles in another layer or due to the concentration of nanoparticles in one layer being higher than the concentration of nanoparticles in another layer. The layers of polymer with nanoparticles are stacked preferably in such a way that the refractive index of these layers increases from one part of the optical composite material towards another, forming a refractive index gradient. The layers can be produced in the form of spherical elements and stacked to create a radial-spherical refractive index gradient, while the wearable optical device itself is implemented in the form of a contact lens.

The technical effect, as related to the method, consists in making it easier to produce the optical composite material with a high refractive index gradient. As related to the method, said problem has been solved, and the technical effect has been achieved, by that the method of producing the optical composite material comprises the following steps: (i) producing the nanoparticles, (ii) distributing the nanoparticles over the polymer, (iii) forming at least two layers of optically transparent polymer with nanoparticles, wherein said layers have different refractive indices, building-up the optical composite material from the layers obtained in step (iii), wherein in step (i) the nanoparticles are produced from high-refractive material having the refractive index higher than 2.8 using the method of femtosecond laser fragmentation or ablation in liquid, in step (ii) the nanoparticles are distributed over the polymer by mixing in such a way that the difference of refractive indices of at least two said layers comprises not less than 0.3, in step (iii) the layers of polymer with nanoparticles are formed on substrates using the centrifugation process and are polymerized, in step (iv) the optical composite material is formed by superimposing the layers produced in step (iii), using the liquid transfer method. In step (ii), the nanoparticles are mixed in different concentrations or different sizes for different layers. In step (iv), the layers of polymer, produced in step (iii), with nanoparticles of different concentrations are preferably stacked in such a way that the concentration of nanoparticles in the layers increases from one part of the optical composite material towards another. In step (iv), the optical composite material can be formed in a fixture with a spherical inner surface. The liquid used for laser fragmentation or ablation in step (i), as well as the liquid used for transferring the layers in step (iv), is preferably water, alcohol, or acetone.

### BRIEF DESCRIPTION OF DRAWINGS

FIG. 1 represents the diagram showing the relationship between the magnitude of the achieved angular field of view and the difference between the refractive indices of the layers of optical composite material;

FIG. 2 represents an embodiment of a flat optical composite material with radial refractive index gradient;

FIG. 3 represents the cross-section of the optical composite material with the layers in the form of spherical elements and with the radial-spherical gradient of refractive index for the suggested device in the form of a contact lens;

FIG. 4 represents the diagram of image generation by an unaided eye (120-degree field of view);

FIG. 5 represents the diagram of image generation using a wearable optical device in the form of a contact lens with radial-spherical refractive index gradient, wherein said lens is produced of two layers (190-degree field of view);

FIG. 6 represents the optical diagram of image generation using a wearable optical device in the form of a contact lens with radial refractive index gradient (220-degree field of view);

FIG. 7 represents the diagram of image generation using a wearable optical device in the form of glasses with a fisheye element (325-degree field of view);

FIG. 8 represents the process flow diagram of step (i) to produce nanoparticles using a femtosecond laser;

FIG. 9 represents the schematic diagram of step (iii) to form the layers of polymer with nanoparticles on substrates using the centrifugation process;

FIG. 10 represents the diagram of forming the optical composite material from the layers with nanoparticles in different concentrations in step (iv);

FIG. 11 represents the diagram of forming the optical composite material from the layers with nanoparticles in different sizes in step (iv).

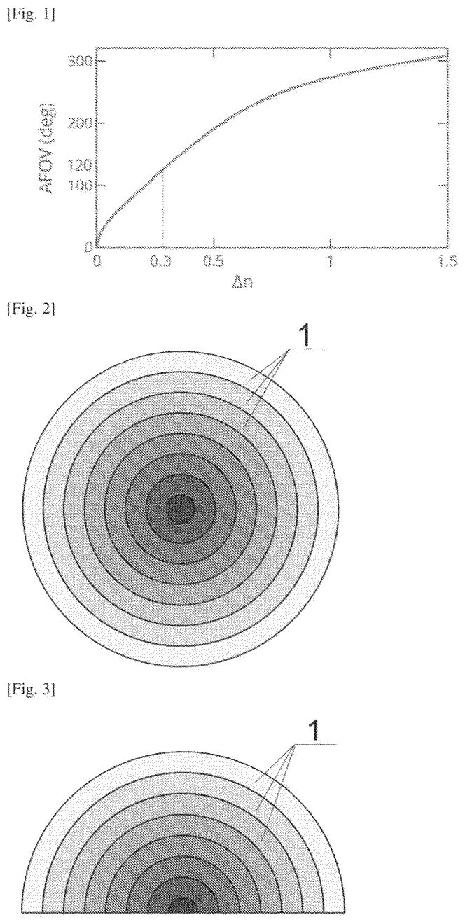

### DESCRIPTION OF EMBODIMENTS

The suggested wearable optical device is produced using a composite material from an optically transparent polymer with a refractive index gradient. The most suitable for such application are such polymers as polyvinyl alcohol (PVA, (C₂H₄O)ₙ), hydroxyethyl methacrylate, polydimethylsiloxane (PDMS, (C₂H₆OSi)ₙ), polylactide (PLA, (C₃H₄O₂)ₙ), polymethyl methacrylate (PMMA, (C₅H₈O₂)ₙ), polymethylpentene (PMP, (C₆H₄O₂)ₙ), polycarbonate (PC, (C₁₆H₁₄O₃)ₙ) or polyetherimide (PEI, (C₃₇H₂₄O₆N₂)ₙ), which have the refractive index in the range from 1.3 to 1.8.

Also acceptable are such polymers as polyethylene naphthalate and isomers thereof, such as 2,6-, 1,4-, 1,5-, 2,7- and 2,3-polyethylene naphthalate; polyalkylene terephthalates, such as polyethylene terephthalate, polybutylene terephthalate and poly-1,4-cyclohexanedimethyleneterephthalate; polyimides, such as polyacrylimides; styrene polymers, such as atactic, isotactic and syndiotactic polystyrene, α-methylpolystyrene, para-methylpolystyrene; polycarbonates, such as bisphenol-A-polycarbonate; poly(meth)acrylates, such as poly(isobutylmethacrylate), poly(propylmethacrylate), poly(ethylmethacrylate), poly(methylmethacrylate), poly(butylacrylate) and poly(methylacrylate) (as used herein, the term “(meth)acrylate” denotes acrylate or methacrylate); cellulose derivatives, such as ethylcellulose, cellulose acetate, cellulose propionate, cellulose acetate butyrate and cellulose nitrate; polyalkylene polymers, such as polyethylene, polypropylene, polybutylene, polyisobutylene and poly(4-methyl)pentene; fluorinated polymers, such as perfluoroalkoxy resins, polytetrafluoroethylene, fluorinated copolymers of ethylene and propylene, polyvinylidene fluoride and polychlorotrifluoroethylene and copolymers thereof; chlorinated polymers, such as polydichlorstyrene, polyvinylidene chloride and polyvinyl chloride; polysulfones; polyethersulfones; polyacrylonitrile; polyamides; polyvinylacetate; polyetheramides. Also suitable are such copolymers as styreneacrylonitrile copolymer, preferably containing 10 to 50 wt %, preferably 20 to 40 wt %, of acrylonitrile, styrene and ethylene copolymer; and poly(ethylene-1, 4-cyclohexylendimethyleneterephthalate). Further polymers include bulk-polymerized or grafted copolymers; acrylic rubber; isoprene; isobutylene-isoprene; butadiene rubber; butadiene-styrene-vinylpyridine; butyl rubber; polyethylene; chloroprene; epichlorohydrin rubber; ethylene-propylene; ethylene-propylene-diene; nitrile-butadiene; polyisoprene; silicone resin; styrene-butadiene and urethane rubber.

Producing the optical composite material from at least two layers with the difference of refractive indices of at least 0.3 has shown an unexpected technical effect of enhancing the device functionality by means of expanding the field of view up to the level exceeding the physiological capabilities of the human eye (over 120 degrees), i.e., forming a panoramic vision. Considering the state of the art, such a high gradient can be achieved by producing said material from two or more polymer layers 1 with different refractive indices resulting from the presence of nanoparticles 2 of high-refractive material (n>2.8).

Said high-refractive material can be non-layered solids having high refractive index and high transparency in the visible band, such as ZnO, TiO₂ or ZnS. However, the most promising for the use are van der Waals materials consisting of two-dimensional layers bonded together by the van der Waals forces: transition metal dichalcogenide, hexagonal boron nitride (hBN), graphite (Gr), MoS₂, MoSe₂, WS₂, WSe₂, SnS₂, SnSe₂, PtS₂, PtSe₂, PtTe₂, ReS₂, ReSe₂, Cd₃As₂, Cd₃Sb₂, Cr₂AlC, Cr₂C, Mn₂AlC, Mo₂C, Mo₂Ga₂C, Mo₃AlC₂, Nb₂AlC, Nb₂C, Nb₄AlC₃, Nb₄C₃, Ta₂C, Ta₄AlC₃, Ti₂AlC, Ti₂AlN, Ti₂C, Ti₂N, Ti₃AlC₂, Ti₃C₂, Ti₃CN, Ti₃SiC₂, Ti₄N₃, V₂AlC, V₂C, V₄AlC₃, V₄C₃, PdS₂, PdSe₂, PdTe₂, ZrS₂, ZrSe₂, GaSe, Sb₂Te₃, GaS, GaSe, GaTe, Ca(OH)₂, Mg(OH)₂, MnO₂, MoO₃, Sb₂O₃, Sb₂OS₂, Sb₂S₃, Sb₂Se₃, Sb₂Te₃, As₂S₃, As₂Se₃, As₂Te₃, Bi₂O₂Se, Bi₂S₃, Bi₂Se₃, Bi₂Te₃, BiSbTe₃, AsP, CdI₂, CdPS₃, CuS, CoPS₃, Cr₂Ge₂Te₆, Cr₂S₃, CrBr₃, CrCl₃, CrGeTe₃, CrPS₃, CrSeBr, CuCrP₂S₆, CuIn₇Se₁₁, FeCl₂, FePS₃, FePSe₃, GaGeTe, GaInS₃, GaSeTe, GaSSe, GaPS₄, GaSTe, HfSe₂, HfS₂, In₂S₃, In₂Se₃, InSe, InTe, InSeBr, InSnSe, MoTe₂, WTe₂, NbS₂, NbSe₂, NbSe₃, VSe₂, ZrSe₃, MoSSe, MoWSe₂, MoWS₂, MoWTe₂, MoNbSe₂, MoO_{2.5}Cl_{0.5}, MoReS₂, MoTaSe₂, MoVSe₂, Na₂Co₂TeO₆, Nb₂SiTe₄, NbReS₂, NbReSe₂, NbS₃, Ni₂SiTe₄, Ni₃TeO₆, NiCl₂, NiI₂, NiPS₃, PbI₂, PbTe, ReNbS₂, ReNbSe₂, ReSSe, Sb₂OS₂, SbAsS₃, SbSe, SbSi, SiP, SnPSe₃, SnS, SnSe, TaS₂, TaS₃, TaSe₂, TaWSe₂, TlSe, TiBr₃, SnTe₂, TiS₂, TiS₃, TlGaS₂, TlGaSe₂, TlGaTe₂, TlInS₂, WNbSe₂, WReS₂, ZrS₂, ZnIn₂S₄, ZnPS₃, ZnPSe₃, ZrGeTe₄, ZrS₃, ZrSe₂, ZrTe₂ or ZrTe₃.

Layers 1 can have different refractive indices due to the average size of nanoparticles 2 in one layer being larger than the average size of nanoparticles in another layer or due to the concentration of nanoparticles 2 in one layer being higher than the concentration in another layer.

To form the required gradient and make it possible to expand the field of view up to the level exceeding the physiological capabilities of the human eye, it is sufficient to have two flat layers with the difference of refractive indices comprising at least 0.3. However, to provide a clearer image and minimize aberrations, it is reasonable to form a smoother gradient and to use four or more layers 1. For this purpose, the polymer layers 1 with nanoparticles 2 are stacked preferably in such a way that the refractive index of these layers increases from one part of the optical composite material towards another, forming a refractive index gradient.

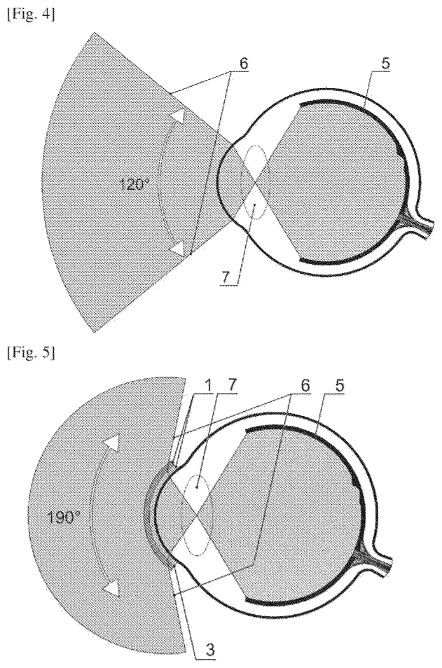

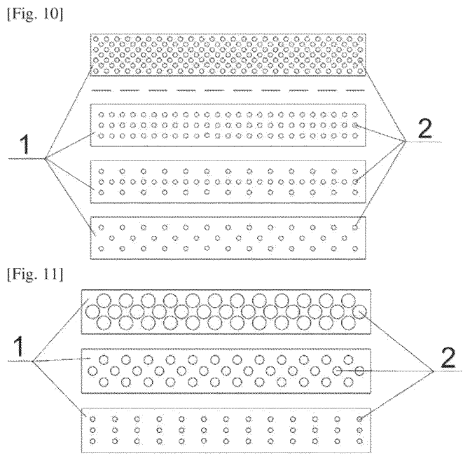

In the simplest flat embodiment, the achieved gradient will be axial [FIG. 10], [FIG. 11]. The radial gradient can be achieved by rolling up the obtained flat multilayer polymer sheet around a rod with the maximum refractive index, and then cutting into discs [FIG. 2]. To form a radial-spherical refractive index gradient, the layers 1 are produced in the form of spherical elements and stacked in an onion-like pattern [FIG. 3]—if the central elements are not stacked, said optical composite material with an appropriate curvature radius can be at once used as a ready wearable optical device in the form of a contact lens 3 [FIG. 5].

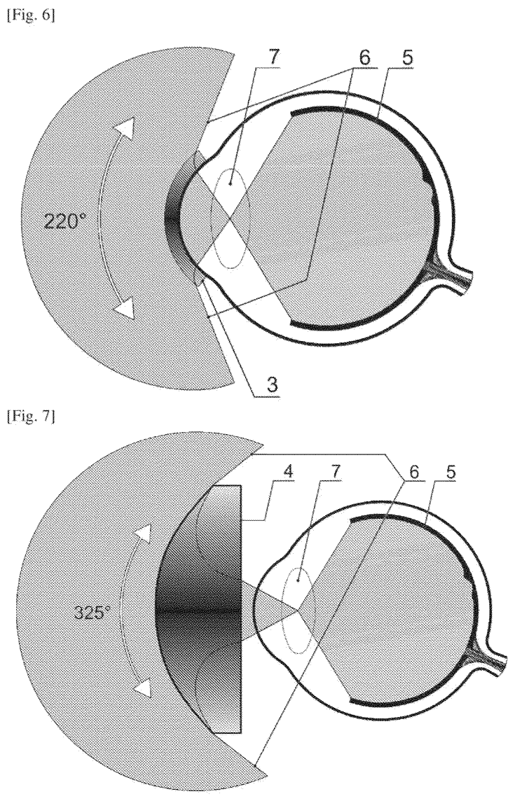

The suggested wearable optical device, for example, in the form of a contact lens 3 [FIG. 5], [FIG. 6] and glasses 4 [FIG. 7], operates as follows.

In the absence of the suggested device, retina 5 of an unaided eye [FIG. 4] is fully exposed to rays 6, forming the image of the objects found in the field of view after passing the crystalline lens 7. In this case, the maximum field of view comprises 120 degrees.

In the simplest case, the suggested wearable device represents the contact lens 3 having two polymer layers 1 with different concentration of nanoparticles 2 [FIG. 5], wherein the layer with the higher refractive index is located on the user's side. In this case, a radial-spherical refractive index gradient is formed that increases the focal distance of the converging rays. This results in that the rays 6, which under usual physiologic conditions of viewing are outside the user's field of view, after the crystalline lens 7 also hit retina 5, and the field of view expands up to 190 degrees.

Similarly, the suggested device can be implemented in the form of glasses 4 with the flat elements consisting of two layers 2 with an axial refractive index gradient [FIG. 10], [FIG. 11].

To further expand the field of view, the suggested device is equipped with an optical composite material with a more complex gradient formed by a plurality of layers with smoothly varying refractive index, which makes it possible to implement more exotic functionality.

When using an optical composite material with a radial refractive index gradient in the contact lens 3 [FIG. 6], the rays 6, successively refracting in layers 1 from outermost to innermost, curve more intensely and form the field of view as wide as up to 220 degrees.

In case the disclosed wearable optical device is implemented in the form of glasses 4 with a fish eye working element [FIG. 7] comprising an optical composite material with a radial refractive index gradient in the form of a cylindrical base with a hemispherical end, the field of view may be expanded up to 325 degrees.

Producing the optical composite material with the aforesaid properties, being the basic element of the suggested wearable optical device, is a non-trivial task as of today, and therefore the method of producing such material is disclosed herein below.

The suggested method of producing the optical composite material comprises the following main steps.

Step (i)—Producing Nanoparticles.

The initial step (i) includes producing nanoparticles 2 from high-refractive material having the refractive index higher than 2.8, using the method of femtosecond laser fragmentation [Besner, S., Kabashin, A. V., Meunier, Y. «Fragmentation of colloidal nanoparticles by femtosecond laser-induced supercontinuum generation», Appl. Phys. Let. 89(23), 233122, 2006] or ablation [Tselikov, G. I., Ermolaev, G. A., Popov, A. A., Tikhonowski, G. V., Panova, D. A., Taradin, A. S., Vyshnevyy, A. A., Syuy, A. V., Klimentov, S. M., Novikov, S. M., Evlyukhin, A. B., Kabashin, A. V., Arsenin, A. V., Novoselov, K. S., Volkov, V. S. «Transition metal dichalcogenide nanospheres for high-refractive-index nanophotonics and biomedical theranostics», PNAS 119(39), e2208830119, 2022] in liquid, for example, water, alcohol, or acetone. Said methods are reasonably simple and demonstrate good controllability of the process parameters, and, what is most important, high quality of the produced nanoparticles 2 with the degree of dispersion varying in a wide range.

As stated above, the most preferable version of said high-refractive material is a broad range of van der Waals materials comprising two-dimensional layers bonded together by the van der Waals forces. The advantage of the chosen femtosecond methods of producing nanoparticles 2 in this case additionally consists in that it is possible to keep the unique optical properties of the source material, which are resulted from its multilayer structure, owing to the extremely short (femtosecond) duration of the process of destructing the source material and producing nanoparticles 2.

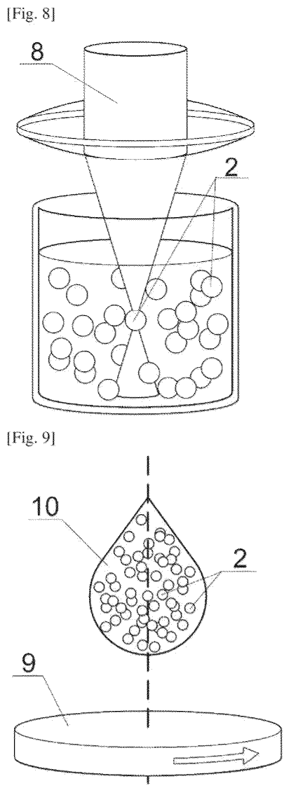

Laser fragmentation or ablation [FIG. 8] is performed using the ray 8 of a femtosecond pulse laser, with the liquid being constantly agitated until the required concentration of nanoparticles 2 is achieved in the produced solution. This results in producing nanoparticles 2 passivated with OH-group and having zeta potential in the range from −50 to −30 mV, enabling their dissolution in the polymer without any additional functionalization (chemical treatment). At this step, the diameter of nanoparticles 2 varies in the range from 1 to 250 nm. Discrimination of nanoparticles 2 by size is accomplished using the centrifugation process [FIG. 9], with the rotation speed increasing from 200 to 8000 rpm, which results in forming monodispersed solutions (Robertson, J. D., Rizzello, L., Avila-Olias, M., Gaitzsch, J., Contini, C., Magon, M. S., Renshaw, S. A., Bataglia, G. «Purification of Nanoparticles by Size and Shape», Scientific Reports 6, 27494, 2016).

Step (ii)—Distributing Nanoparticles Over the Polymer.

The monodispersed solution with nanoparticles 2 that was obtained in the previous step is then distributed over the optically transparent polymer (see above for specific embodiments of the polymers) by means of mechanical mixing. For different layers 1, nanoparticles 2 are mixed in different concentrations and/or different sizes, wherein the specific parameters of the process are defined by the desired refractive index value n for the produced layer in the range from 1.3 to 3.95 for the polymer-nanoparticles mixture within the limits of the effective medium approximation. To realize the required refractive index gradient, the refractive index difference between at least two produced polymer-nanoparticles mixtures must be not lower than 0.3.

To achieve a uniform distribution of nanoparticles 2 within the polymer, the produced mixture is additionally subjected to ultrasonic treatment.

Step (iii)—Forming the Layers.

This step comprises forming at least two layers 1 of optically transparent polymer with nanoparticles 2. The layers of polymer with nanoparticles are formed on rotating substrates 9 using the centrifugation process (spin coating) (Mouhamad Y., Mokarian-Tabari P., Clarke N., Jones R. A. L., and Geoghegan M. «Dynamics of polymer film formation during spin coating, Journal of Applied Physics 116, 123513, 2014) from a drop 10 and are polymerized to produce a film of a predefined thickness (in the range from 10 to 10000 nm) with subsequent drying [FIG. 9]. The difference between the refractive indices of the layers with maximum and minimum concentration and/or size of nanoparticles 2 must be not less than 0.3.

Step (iv)—Forming the Optical Composite Material.

The layers 1 that were produced in the previous step and have different concentrations and/or sizes of nanoparticles 2 and, consequently, different refractive indices are superimposed, using the liquid transfer method [R. S. Weatherup, «2D Material Membranes for Operando Atmospheric Pressure Photoelectron Spectroscopy», Topics in Catalysis 61, 2085-2102, 2018], to form a consolidated multilayer optical composite material. The liquid used for transferring the layers 1 is water, alcohol, or acetone.

In the most preferable embodiment, the layers 1 of the polymer with nanoparticles 2 are stacked in such a way that the concentration of nanoparticles 2 therein increases from one side of the optical composite material towards the other to form the refractive index gradient in the range from 0.3 to 2.8. For this purpose, the layers are used that have different concentrations [FIG. 10] or sizes [FIG. 11] of nanoparticles 2.

The refractive index gradient can be both axial and radial or radial-spherical. The axial refractive index gradient is achieved by stacking the layers 1 of polymer films with varying refractive index in the thickness-wise direction and forming the optical composite material in the form of a multilayer polymer sheet. Said sheet can be rolled up and then cross-cut to produce the discs with the radial refractive index gradient [FIG. 2]. Said flat optical composite materials can be used to produce wearable optical devices in the form of glasses 4, as well as for other applications.

To form the radial-spherical gradient, in particular, to be used for producing the wearable optical device in the form of a contact lens 3, the composite material is formed in a fixture with spherical inner surface. In the process, the layers 1 are bent with the curvature radius of the lens that is being formed and are stacked one into another in an onion-like pattern [FIG. 3].

### INDUSTRIAL APPLICABILITY

The disclosed method makes it possible rather easily, using the state of the art technology, to produce an optical composite material with high transmittance (up to 99%) for the spectral interval in the range of 300-800 nm and with the refractive index gradient not less than 0.3, while producing a wearable optical device using said material makes it possible to enhance the device functionality by means of expanding the field of view up to the level exceeding physiological capabilities of the human eye (from 120 to, at least, 325 degrees).

### EXAMPLES

### Example 1

To produce high-refractive MoS₂ nanoparticles in step (i), a femtosecond laser was used having the pulse length of 100 fs, pulse energy of 100 μJ, wavelength of 1030 nm, and recurrence frequency of 10 kHz. In the process of fragmentation, the source MoS₂ crystal resided in deionized water, and, using a galvo-scanner, the crystal surface was scanned by a focused laser spot at the scan speed of 1 m/s. The exposure to radiation continued until achieving the final nanoparticles concentration of 0.1 mg/ml. Then, using the centrifugation process, the produced colloidal solution is separated into 6 monodispersed solutions (dispersion of distribution is less than 10%), with the average diameter of nanoparticles being 34, 42, 53, 65, 78, and 100 nm.

In step (ii), the produced solutions of nanoparticles were distributed over the polymer (polymethyl methacrylate) by means of mechanical mixing with subsequent ultrasonic treatment.

In step (iii), the centrifugation process (spin coating) was used to form several layers in the form of 100 nm thick films having a volumetric concentration of nanoparticles (choose the size less than 60 nm) of 0, 10, 20, 30, 40, 50, 60, and 70%, which corresponds to effective refractive index of said layers being 1.485, 1.85, 2.2, 2.55, 2.9, 3.25, 3.6, and 3.95 at the wavelength of 750 nm.

In step (iv), the films were transferred one over another using the liquid transfer method and then superimposed to form the optical composite material in the form of a multilayer polymer sheet with the refractive index gradient of 2.465 at the wavelength of 400 nm. The produced sheet was rolled up into a cylinder with a radial refractive index gradient, from which cylinder a fish eye optical element was cut out with the one end being flat and the other being hemispherical. The transmittance of the produced wearable optical device based on such element [FIG. 10] comprised 99%, with the field of view being 325 degrees.

### Example 2

To produce high-refractive ZnS nanoparticles of 20 nm in size in step (i) employing the method of laser fragmentation in liquid, a femtosecond laser was used having the pulse length of 100 fs, pulse energy of 50 μJ, wavelength of 1030 nm and recurrence frequency of 10 kHz. In the process, the ZnS microcrystal having the wurtzite-type crystalline structure and mass of 1 mg was submerged in a cuvette filled with 5 ml of ethanol, and thereafter exposed to an intense ultrasonic treatment at the power level of 150 W during 5 min. As a result, a colloidal solution of ZnS microparticles in ethanol was produced having the weight concentration of 0.2 mg/ml, which solution was then subjected to femtosecond laser fragmentation procedure. For this purpose, the laser irradiation with the above described parameters was focused at the depth of 1 cm from the surface of the colloidal solution, while the colloidal solution itself was stirred using a magnetic stirrer at the speed of 300 rpm. The laser fragmentation during 30 minutes resulted in producing a colloidal solution of ZnS nanoparticles of spherical form having the average size of 20 nm and volumetric concentration of 1*10¹³ pcs/ml.

In step (ii), the colloidal solution of ZnS nanoparticles was mechanically mixed with polyvinyl alcohol (a water-soluble thermoplastic polymer having the refractive index of 1.5 at the wavelength of 400 nm) in predetermined proportions. The produced mixture was subjected to ultrasonic agitation, and then the centrifugation process (spin coating) was used to form a 100 nm thick film. Thereby, a set of 100 nm thick layers (polymer films) is produced having various volumetric concentration of ZnS nanoparticles comprising 0, 10, 20, 30, 40, 50, 60, and 70%, which corresponds to effective refractive index of the layers being 1.59, 1.68, 1.77, 1.87, 1.98, 2.08, and 2.20 at the wavelength of 400 nm.

In step (iv), the films were transferred one over another using the liquid transfer method and then superimposed in a hemispherical fixture to form the optical composite material with the refractive index gradient of 0.61 at the wavelength of 400 nm. The produced contact lens has the transmittance of 99% and the field of view of 220 degrees.

1. A wearable optical device containing an optical composite material comprising at least two layers of optically transparent polymer with nanoparticles, with said layers having different refractive indices, wherein the nanoparticles are made of high-refractive material having the refractive index higher than 2.8, and the difference between the refractive indices of said layers comprises not less than 0.3, with said high-refractive material being a van der Waals material consisting of two-dimensional layers bonded together by the van der Waals forces.

2. The wearable optical device according to claim 1, wherein said van der Waals material is a transition metal dichalcogenide.

3. The wearable optical device according to claim 1, wherein said van der Waals material is a hexagonal boron nitride, graphite, MoS₂, MoSe₂, WS₂, WSe₂, SnS₂, SnSe₂, PtS₂, PtSe₂, PtTe₂, ReS₂, ReSe₂, Cd₃As₂, Cd₃Sb₂, Cr₂AlC, Cr₂C, Mn₂AlC, Mo₂C, Mo₂Ga₂C, Mo₃AlC₂, Nb₂AlC, Nb₂C, Nb₄AlC₃, Nb₄C₃, Ta₂C, Ta₄AlC₃, Ti₂AlC, Ti₂AlN, Ti₂C, Ti₂N, Ti₃AlC₂, Ti₃C₂, Ti₃CN, Ti₃SiC₂, Ti₄N₃, V₂AlC, V₂C, V₄AlC₃, V₄C₃, PdS₂, PdSe₂, PdTe₂, ZrS₂, ZrSe₂, GaSe, Sb₂Te₃, GaS, GaSe, GaTe, Ca(OH)₂, Mg(OH)₂, MoO₃, Sb₂₀₃, Sb₂OS₂, Sb₂S₃, Sb₂Se₃, Sb₂Te₃, As₂S₃, As₂Se₃, As₂Te₃, Bi₂₀₂Se, Bi₂S₃, Bi₂Se₃, Bi₂Te₃, BiSbTe₃, AsP, CdI₂, CdPS₃, CuS, CoPS₃, Cr₂Ge₂Te₆, Cr₂S₃, CrBr₃, CrCl₃, CrGeTe₃, CrPS₃, CrSeBr, CuCrP₂S₆, CuIn₇Se₁₁, FeCl₂, FePS₃, FePSe₃, GaGeTe, GaInS₃, GaSeTe, GaSSe, GaPS₄, GaSTe, HfSe₂, HfS₂, In₂S₃, In₂Se₃, InSe, InTe, InSeBr, InSnSe, MoTe₂, WTe₂, NbS₂, NbSe₂, NbSe₃, VSe₂, ZrSe₃, MoSSe, MoWSe₂, MoWS₂, MoWTe₂, MoNbSe₂, MoO_{2.5}Cl_{0.5}, MoReS₂, MoTaSe₂, MoVSe₂, Na₂Co₂TeO₆, Nb₂SiTe₄, NbReS₂, NbReSe₂, NbS₃, Ni₂SiTe₄, Ni₃TeO₆, NiCl₂, NiI₂, NiPS₃, PbI₂, PbTe, ReNbS₂, ReNbSe₂, ReSSe, Sb₂OS₂, SbAsS₃, SbSe, SbSi, SiP, SnPSe₃, SnS, SnSe, TaS₂, TaS₃, TaSe₂, TaWSe₂, TlSe, TiBr₃, SnTe₂, TiS₂, TiS₃, TlGaS₂, TlGaSe₂, TlGaTe₂, TlInS₂, WNbSe₂, WReS₂, ZrS₂, ZnIn₂S₄, ZnPS₃, ZnPSe₃, ZrGeTe₄, ZrS₃, ZrSe₂, ZrTe₂ or ZrTe₃.

4. The wearable optical device according to claim 1 wherein the refractive index of said polymer ranges from 1.3 to 1.8.

5. The wearable optical device according to claim 4, wherein said polymer is polyvinyl alcohol, hydroxyethyl methacrylate, poly-dimethylsiloxane, polylactide, polymethyl methacrylate, polymethylpentene, polycarbonate or polyetherimide.

6. The wearable optical device according to claim 1, wherein said layers have different refractive indices due to the size of nanoparticles in one layer being larger than the size of nanoparticles in another layer.

7. The wearable optical device according to claim 1, wherein said layers have different refractive indices due to the concentration of nanoparticles in one layer being higher than the concentration of nanoparticles in another layer.

8. The wearable optical device according to any one of claims 1-7, wherein the layers of polymer with nanoparticles are stacked in such a way that the refractive index of these layers increases from one part of the optical composite material towards another, forming a refractive index gradient.

9. The wearable optical device according to claim 8, wherein the layers are produced in the form of spherical elements and are stacked to create a radial-spherical refractive index gradient.

10. The wearable optical device according to claim 9, wherein it is implemented as a contact lens.

11. A method of producing the optical composite material, the method comprising the following steps:
(i) producing nanoparticles,
(ii) distributing nanoparticles over the polymer,
(iii) forming at least two layers of optically transparent polymer with nanoparticles, with said layers having different refractive indices,
(iv) forming the optical composite material from the layers produced in step (iii), wherein:
in step (i), the nanoparticles are produced from a high-refractive material having the refractive index higher than 2.8, using the method of femtosecond laser fragmentation or ablation in liquid,
in step (ii), the nanoparticles are distributed over the polymer by mixing in such a way that the difference of refractive indices of at least two said layers comprises not less than 0.3,
in step (iii), the layers of polymer with nanoparticles are formed on substrates using the centrifugation process and are polymerized, and
in step (iv), the optical composite material is formed by superimposing the layers produced in step (iii), using the liquid transfer method.

12. The method according to claim 11, wherein in step (ii) the nanoparticles are mixed in different concentrations for different layers.

13. The method according to claim 11, wherein in step (ii) the nanoparticles are mixed in different sizes for different layers.

14. The method according to claim 11, wherein in step (iv) the layers of polymer, produced in step (iii), with nanoparticles of different concentrations are stacked in such a way that the concentration of nanoparticles in the layers increases from one part of the optical composite material towards another.

15. The method according to claim 11, wherein in step (iv) the optical composite material is formed in a fixture with spherical inner surface.

16. The method according to claim 11, wherein the liquid for laser fragmentation or ablation in step (i) is water, alcohol, or acetone.

17. The method according to claim 11, wherein the liquid for transferring the layers in step (iv) is water, alcohol, or acetone.
